(19) United States
(12) Patent Application Publication
(10) Pub. No.: US 2026/0138466 A1
(43) Pub. Date: May 21, 2026

(54) OPERATING SYSTEM FOR A HYBRID POWER INVERTER

(71) Applicant: GM GLOBAL TECHNOLOGY OPERATIONS LLC, Detroit, MI (US)

(72) Inventors: Benjamin S. Ngu, Rochester Hills, MI (US); Yilun Luo, Ann Arbor, MI (US); Chandra S. Namuduri, Troy, MI (US); Michael Z. Pieszala, Panama City, FL (US); Brian A. Welchko, Oakland Township, MI (US); Khorshed Mohammed Alam, Canton, MI (US)

(73) Assignee: GM GLOBAL TECHNOLOGY OPERATIONS LLC, Detroit, MI (US)

(21) Appl. No.: 18/953,405

(22) Filed: Nov. 20, 2024

(51) Int. Cl. B60L 50/51; H02M 1/00; H02M 7/5387; H02P 27/08

(52) U.S. Cl. CPC B60L 50/51; H02M 1/0095; H02M 7/53875; H02P 27/085; B60L 2210/40

(57) ABSTRACT

An operating system for a hybrid power inverter that is coupled to a multi-phase electric machine includes first gate drivers having wide bandgap (WBG) transistors that are connected to a first subset of transistors, second gate drivers having silicon-based (Si) transistors that are connected to a second subset of transistors, and a controller. The hybrid power inverter includes the first subset of transistors and the second subset of transistors being arranged in phase legs, including a first portion of the phase legs employing the first subset of transistors, and a remaining portion of the phase legs employing the second subset of transistors. The first gate driver controls the first portion of the phase legs at a first switching frequency. The second gate driver controls the second portion of the phase legs at a second switching frequency. The second switching frequency is less than the first switching frequency.

### INTRODUCTION

The concepts described herein relate to operating systems for hybrid power inverters that may be employed to control electric machines that are utilized on vehicles and other devices.

### SUMMARY

There is a need to efficiently control and operate a hybrid power inverter that is coupled to an electric machine. The concepts described herein provide for a method, apparatus, and control system related to operation and control of a hybrid power inverter coupled to a multi-phase electric machine.

An aspect of the disclosure may include an operating system for a hybrid power inverter that is coupled to a multi-phase electric machine. The operating system includes a plurality of first gate drivers having wide bandgap (WBG) transistors, the plurality of first gate drivers being operatively connected to a first subset of transistors of the hybrid power inverter; a plurality of second gate drivers having silicon-based (Si) transistors, the plurality of second gate drivers being operatively connected a second subset of transistors of the hybrid power inverter; and a controller. The controller is operatively connected to the plurality of first gate drivers and the plurality of second gate drivers. The hybrid power inverter includes the first subset of transistors and the second subset of transistors being arranged in a plurality of phase legs, including a first portion of the plurality of phase legs employing the first subset of transistors, and a remaining portion of the plurality of phase legs employing the second subset of transistors, wherein the first subset of transistors includes WBG transistors, and wherein the second subset of transistors includes silicon-based (Si) transistors. The first gate driver is operative to control the first portion of the plurality of phase legs of the hybrid power inverter at a first switching frequency. The second gate driver is operative to control the second of the plurality of phase legs of the hybrid power inverter at a second switching frequency. The second switching frequency is less than the first switching frequency.

An aspect of the disclosure may include the plurality of second gate drivers having integrated-gate bipolar transistors (IGBTs).

Another aspect of the disclosure may include the plurality of first gate drivers having silicon carbide (SiC) metal-oxide-silicon field effect transistors (MOSFETs).

Another aspect of the disclosure may include the plurality of first gate drivers having Gallium nitride (GaN) MOSFETs.

Another aspect of the disclosure may include the plurality of second gate drivers each comprising a variable current based gate driver; and the plurality of first gate drivers each comprising a variable gate resistance voltage based gate driver.

Another aspect of the disclosure may include the first portion of the plurality of phase legs including a first upper leg arranged in series with a first lower leg; wherein the plurality of first gate drivers are operative to control the first upper leg and the first lower leg such that there is a first deadtime between deactivation of the first upper leg and activation of the first lower leg; and wherein the plurality of first gate drivers are operative to control the first upper leg and the first lower leg such that there is a second deadtime between deactivation of the first lower leg and activation of the first upper leg; wherein the second deadtime differs from the first deadtime.

Another aspect of the disclosure may include the second deadtime and the first deadtime being selected to minimize third quadrant losses on semiconductor switches capable of faster voltage changes.

Another aspect of the disclosure may include the first portion of the plurality of phase legs having a first upper leg arranged in series with a first lower leg; wherein the remaining portion of the plurality of phase legs has a second upper leg arranged in series with a second lower leg; wherein the first gate driver is operative to control the first upper leg and the first lower leg such that there is a first deadtime between deactivation of the first upper leg and activation of the first lower leg; wherein the first gate driver is operative to control the first upper leg and the first lower leg such that there is a second deadtime between deactivation of the first lower leg and activation of the first upper leg; wherein the second gate driver is operative to control the second upper leg and the second lower leg such that there is a third deadtime between deactivation of the second upper leg and activation of the second lower leg; wherein the second gate driver is operative to control the second upper leg and the second lower leg such that there is a fourth deadtime between deactivation of the second lower leg and activation of the second upper leg, and wherein the first deadtime, the second deadtime, the third deadtime and the fourth deadtime differ.

Another aspect of the disclosure may include the second switching frequency being 10 kHz, and the first switching frequency being at least 20 kHz.

Another aspect of the disclosure may include the plurality of first gate drivers being operative to control the first portion of the plurality of phase legs of the hybrid power inverter at a first slew rate, and the plurality of second gate drivers being operative to control the remaining portion of the plurality of phase legs of the hybrid power inverter at a second slew rate; wherein the first slew rate differs from the second slew rate.

Another aspect of the disclosure may include the plurality of first gate drivers being operative to control the first portion of the plurality of phase legs of the hybrid power inverter at a first bias supply voltage; and the plurality of second gate drivers being operative to control the remaining portion of the plurality of phase legs of the hybrid power inverter at a second bias supply voltage; wherein the first bias supply voltage differs from the second bias supply voltage.

Another aspect of the disclosure may include an operating system for a hybrid power inverter that is coupled to a multi-phase electric machine that includes: a plurality of first gate drivers, the plurality of first gate drivers being operatively connected to a first subset of transistors of the hybrid power inverter; a plurality of second gate drivers, the plurality of second gate drivers being operatively connected a second subset of transistors of the hybrid power inverter; and a controller, the controller being operatively connected to the plurality of first gate drivers and the plurality of second gate drivers; wherein the hybrid power inverter includes the first subset of transistors and the second subset of transistors arranged in a plurality of phase legs, including a first portion of the plurality of phase legs employing the first subset of transistors, and a remaining portion of the plurality of phase legs employing the second subset of transistors, wherein the first subset of transistors includes WBG transistors, and wherein the second subset of transistors includes silicon-based (Si) transistors; wherein the controller is operative to control the plurality of first gate drivers to control the first portion of the plurality of phase legs of the hybrid power inverter at a first switching frequency; wherein the controller is operative to control the plurality of second gate drivers to control the remaining portion of the plurality of phase legs of the hybrid power inverter at a second switching frequency; and wherein the second switching frequency is less than the first switching frequency.

Another aspect of the disclosure may include a vehicle employing an operating system for a hybrid power inverter that is coupled to a multi-phase electric machine in a manner described herein.

The above summary is not intended to represent every possible embodiment or every aspect of the present disclosure. Rather, the foregoing summary is intended to illustrate some of the aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates a multi-phase motor drive system disposed on a vehicle, in accordance with the disclosure.

FIG. 2 schematically illustrates elements of an embodiment of a hybrid power inverter system including a multi-phase electric machine and operating system, in accordance with the disclosure.

FIG. 3 graphically illustrates pulsewidth-modulated control signals that are generated by a controller to control a multi-phase electric machine, in accordance with the disclosure.

FIG. 4 graphically illustrates a plurality of pulsewidth-modulated control signals that are generated by a controller to control a multi-phase electric machine, in accordance with the disclosure.

FIG. 5 graphically illustrates control elements related to operation of a portion of an embodiment of a hybrid power inverter described herein, in accordance with the disclosure.

FIG. 6 graphically illustrates control elements related to operation of a portion of an embodiment of a hybrid power inverter, in accordance with the disclosure.

FIG. 7 graphically illustrates control elements related to operation of a portion of an embodiment of a hybrid power inverter, in accordance with the disclosure.

FIG. 8 schematically and graphically illustrates control elements related to operation of a portion of an embodiment of a hybrid power inverter described herein, including a configurable gate driver, in accordance with the disclosure.

FIG. 9 graphically illustrates data related to operation of a portion of an embodiment of the hybrid power inverter described herein, including time-coincident traces of voltage levels associated with tuned desaturation thresholds, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description to provide a thorough understanding of the embodiments disclosed herein, some embodiments can be practiced without some of these details. Moreover, for the purpose of clarity, certain technical material that is understood in the related art has not been described in detail to avoid unnecessarily obscuring the disclosure.

For purposes of convenience and clarity, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein. Throughout the drawings, corresponding reference numerals indicate like or corresponding parts and features.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

Embodiments may be described herein in terms of functional and/or logical block components and various processing steps. It should be appreciated that such block components may be realized by a combination or collection of mechanical and electrical hardware, software, and/or firmware components configured to perform the specified functions.

The use of ordinals such as first, second and third does not necessarily imply a ranked sense of order, but rather may distinguish between multiple instances of an act or structure.

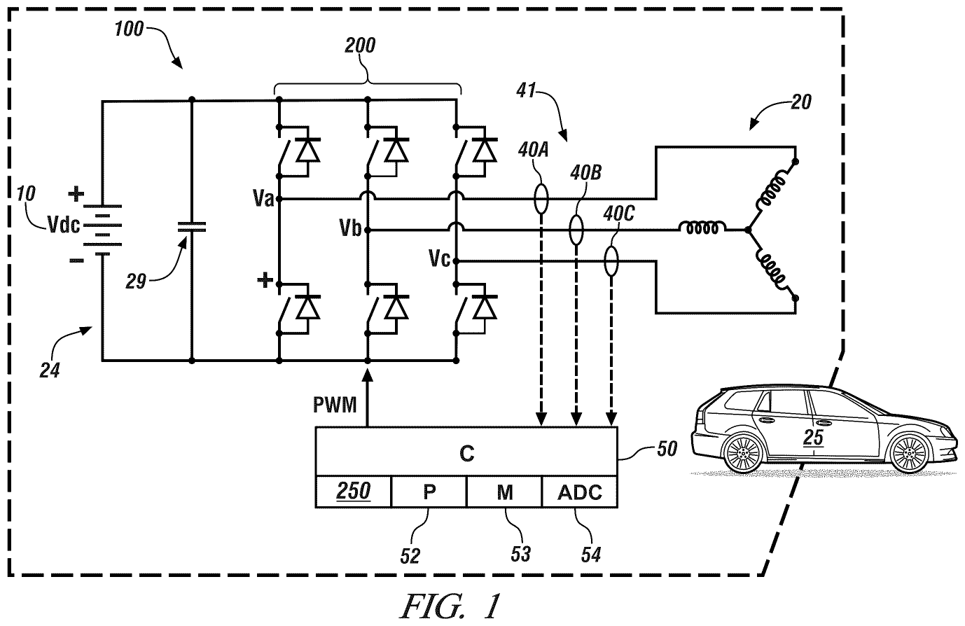

Referring to the drawings, FIG. 1, consistent with embodiments disclosed herein, illustrates a non-limiting example of a multi-phase motor drive system 100. In one embodiment, the multi-phase motor drive system 100 may be disposed to provide propulsion torque in a vehicle 25. The vehicle 25 may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure.

The multi-phase motor drive system 100 includes a rechargeable energy storage device (RESS) 10, a multi-phase rotary electric machine (electric machine) 20, a hybrid power inverter system 200, and a controller (C) 50. The RESS 10 is electrically coupled to the hybrid power inverter system 200 via a high-voltage bus 24, with one or more capacitors 29, and the hybrid power inverter system 200 is coupled to the electric machine 20 via power cables 41. The hybrid power inverter system 200 is operative to transform DC electric energy from the RESS 10 to AC electric energy that is supplied to phases of the multi-phase rotary electric machine 20 to generate torque in a torque generative mode, and is operative to transform AC electric energy generated by the multi-phase rotary electric machine 20 to DC electric energy that is storable in the RESS 10 in an electric power generative mode, in response to control commands from the controller 50. The controller 50 is programmed in software and equipped in hardware to execute instructions to control the hybrid power inverter system 200. While it may be practical to implement the following approach digitally in a microcontroller, it may instead be implemented employing discrete components in one embodiment.

The multi-phase motor drive system 100 as depicted herein is a three-phase DC-AC system. It is appreciated that the concepts described herein may be applied to any of various inverter topologies and multi-phase arrangements, including 2 phase, 4 phase, 5 phase, 6 phase, etc., H-bridges, Z-types, T-types, neutral point clamped (NPC) arrangements, multi-level arrangements, etc., without limitation. Furthermore, the concepts described herein apply to various power conversion topologies, including DC-AC, AC-DC, DC-DC, AC-AC, etc., without limitation.

Furthermore, although this is described in context of a vehicle application, the concepts described herein may be applied to stationary systems including public or private electrical grid storage systems.

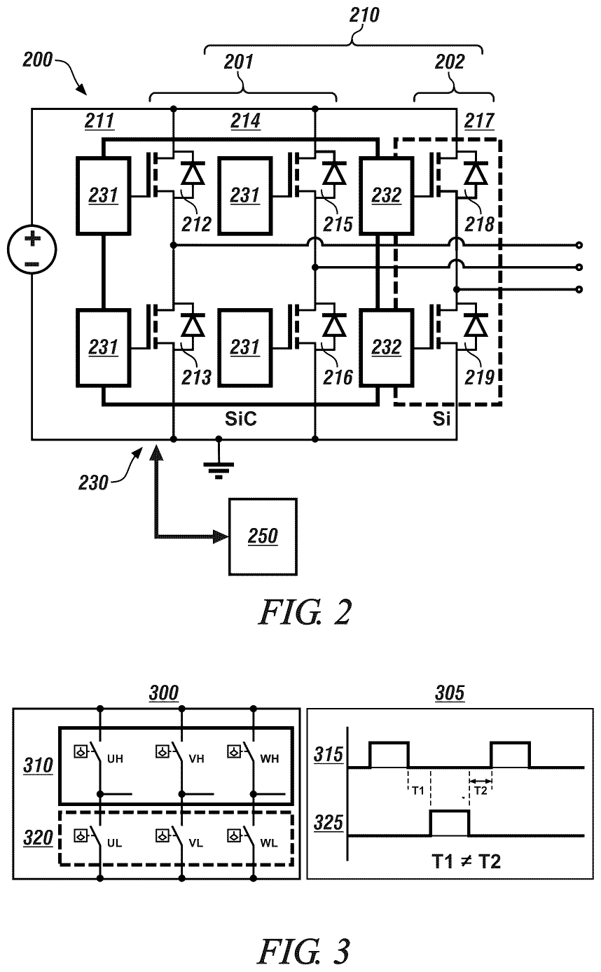

Elements of one embodiment of the hybrid power inverter system 200 are described with reference to FIG. 2. The hybrid power inverter system 200 includes control circuits including power transistors for transforming high-voltage DC electric power to high-voltage AC electric power and transforming high-voltage AC electric power to high-voltage DC electric power. The hybrid power inverter system 200 may employ pulsewidth-modulating (PWM) control of the power transistors to convert stored DC electric power originating in the RESS 10 to AC electric power to drive the rotary electric machine 20 to generate torque. Similarly, the hybrid power inverter system 200 converts mechanical power transferred to the rotary electric machine 20 to DC electric power to generate electric energy that is storable in the RESS 10, including as part of a regenerative braking control strategy when employed on-vehicle. The hybrid power inverter system 200 receives motor control commands from the controller 50 and controls inverter states to provide the motor drive and regenerative braking functionality in the rotary electric machine 20.

The RESS 10 is a rechargeable device, e.g., a multi-cell lithium ion or nickel metal hydride battery.

The phase currents delivered to the electric machine 20 may be individually measured via phase current sensors 40A, 40B, 40C using a measurement process in one embodiment.

The controller 50 includes a processor (P) 52 and tangible, non-transitory memory (M) 53 on which is recorded instructions embodying the hybrid power inverter system 200. The controller 50 may also include an analog-to-digital converter (ADC) 54. The ADC 54 may be embodied as an electrical circuit providing a specific sampling rate which provides quantization of the continuous/analog voltage input and outputs a representative digital signal. The memory 53 may include read-only memory (ROM), flash memory, optical memory, additional magnetic memory, etc., as well as random access memory (RAM), electrically-programmable read-only memory (EPROM), a high-speed clock, analog-to-digital (A/D) and/or digital-to-analog (D/A) circuitry, input/output circuitry or devices, and signal conditioning and buffer circuitry.

The controller 50 commands, or causes the hybrid power inverter system 200 to generate a set of pulsewidth modulation signals (arrow PWM). These PWM signals provide switching control of the input voltage used to power the multi-phase rotary electric machine 20.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read-only, programmable read-only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which can be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

The term “signal” refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and similar signals that are capable of traveling through a medium.

The terms “calibration”, “calibrated”, and related terms refer to a result or a process that correlates a desired parameter and one or multiple perceived or observed parameters for a device or a system. A calibration as described herein may be reduced to a storable parametric table, a plurality of executable equations or another suitable form that may be employed as part of a measurement or control routine.

A parameter is defined as a measurable quantity that represents a physical property of a device or other element that is discernible using one or more sensors and/or a physical model. A parameter can have a discrete value, e.g., either “1” or “0”, or can be infinitely variable in value.

FIG. 2 schematically illustrates elements of an embodiment of the hybrid power inverter system 200, which may be an element of the multi-phase motor drive system 100 described with reference to FIG. 1.

The hybrid power inverter system 200 is composed of a hybrid power inverter 210 and an operating system 230. The operating system 230 includes a plurality of first gate drivers 231, a plurality of second gate drivers 232, and a controller 250. The controller 250 is operatively connected to the plurality of first gate drivers 231 and the plurality of second gate drivers 232, which are operatively connected to a plurality of power transistors of the hybrid power inverter 210 to control operation thereof, and thus control operation of the rotary electric machine 20.

The hybrid power inverter 210 in one embodiment and as shown is arranged as a three-phase system, although the concepts described herein are not so limited. The hybrid power inverter 210 is coupled to the RESS via upper and lower bars of high-voltage DC power bus 24. The hybrid power inverter 210 is arranged as a plurality of phase legs, which is, in one embodiment, three phase legs, including first phase leg 211, second phase leg 214, and third phase leg 217. The phase legs are each arranged with an upper leg and a lower leg. The first phase leg 211 includes upper leg including transistor 212, which is arranged in series with lower leg including transistor 213 between the upper and lower bars of high-voltage DC power bus 24. The second phase leg 214 includes upper leg including transistor 215, which is arranged in series with lower leg including transistor 216 between the upper and lower bars of high-voltage DC power bus 24. The third phase leg 217 includes upper leg including transistor 218, which is arranged in series with lower leg including transistor 219 between the upper and lower bars of high-voltage DC power bus 24. The symbols that are employed to depict the transistors 212, 213, 215, 216, 218 and 219 are generic transistor symbols, with the specific types of transistors being described herein.

A first subset of the transistors of the hybrid power inverter 210 are wide bandgap (WBG) transistors, and a second subset of the transistors of the hybrid power inverter 210 are silicon-based (Si) transistors, in one embodiment. WBG transistors may include Gallium nitride (GaN) metal-oxide-silicon field effect transistors (MOSFETs), or, alternatively, silicon carbide (SiC) MOSFETs. The silicon-based (Si) transistors may include integrated-gate bipolar transistors (IGBTs), in one embodiment. A wide bandgap (WBG) switch operates at higher voltages, temperatures, and frequencies than Si-based semiconductors. Thus, WBG switches tend to be smaller, faster, more reliable, and more efficient than Si-based semiconductors.

In one embodiment, the transistors of a first portion 201 of the plurality of phase legs of the hybrid power inverter 210, i.e., upper transistor 212 and lower transistor 213 of the first phase leg 211, and upper transistor 215 and lower transistor 216 of the second phase leg 214, form a first subset of the transistors of the hybrid power inverter 210, and are wide bandgap (WBG) transistors in one embodiment.

In one embodiment, the transistors of a second or remaining portion 202 of the plurality of phase legs of the hybrid power inverter 210, i.e., upper transistor 218 and lower transistor 219 of the third phase leg 217, form a second subset of the transistors of the hybrid power inverter 210, and are silicon-based (Si) transistors in one embodiment.

The operating system 230 includes a plurality of first gate drivers 231, a plurality of second gate drivers 232, and a controller 250.

The first gate drivers 231 are operatively connected to the first subset of transistors of the hybrid power inverter system 200, i.e., the transistors of the first portion 201 of the plurality of phase legs of the hybrid power inverter 210 including upper transistor 212 and lower transistor 213 of the first phase leg 211, and upper transistor 215 and lower transistor 216 of the second phase leg 214 in this embodiment. The first gate drivers 231 employ wide bandgap (WBG) transistors in one embodiment, which are relatively high-speed switching devices. In one embodiment, the first gate drivers 231 employ silicon carbide (SiC) MOSFETs. In one embodiment, first gate drivers 231 employ Gallium nitride (GaN) MOSFETs. In one embodiment, first gate drivers 231 are arranged as variable gate resistance voltage-based gate drivers.

The second gate drivers 232 are operatively connected to the second subset of transistors of the hybrid power inverter system 200, i.e., the transistors of the second or remaining portion 202 of the plurality of phase legs of the hybrid power inverter 210 including upper transistor 218 and lower transistor 219 of the third phase leg 217 in this embodiment. The second gate drivers 232 employ silicon-based (Si) transistors in one embodiment. In one embodiment, the second gate drivers employ IGBT transistors. In one embodiment, the second gate drivers 232 are arranged as variable current based gate drivers.

The first gate drivers 231 are operative to control the first portion 201 of the plurality of phase legs of the hybrid power inverter system 200 at a first switching frequency, and the second gate drivers 232 are operative to control the remaining portion 202 of the plurality of phase legs of the hybrid power inverter at a second switching frequency, wherein the second switching frequency is less than the first switching frequency.

In one non-limiting embodiment, the first switching frequency is 10 kHz, and the second switching frequency is 20 kHz, or 30 kHz, or 50 kHz.

Elements of the hybrid power inverter 210 and operating system 230 described herein provide a control scheme that lowers motor losses in ECOP operating regions by switching the phases of an inverter with WBG switches at higher switching frequencies (as high as can be supported) relative to the non-WBG switch phases. The higher inverter switching frequency (and losses) would be traded off for minimized motor core losses due to the higher harmonics in the motor phase currents.

Furthermore, utilizing different gate driver types (AGD, VCGD, standard GD) based on different switches in the TPIM to optimize performance and cost (Si/SiC/GaN/etc). Variable Rg voltage based gate drivers and variable current based gate drivers offer additional flexibility in controlling switching losses of the power semiconductors, however the cost tradeoff to utilize them depends on the amount of achievable efficiency gained. Certain semiconductor types are not as receptive to improved switching losses when using these advanced gate drivers

FIG. 3 graphically illustrates a portion of an embodiment of a hybrid power inverter 300 and a portion of corresponding pulsewidth-modulated control scheme 305 for controlling the hybrid power inverter 300. In this embodiment, the hybrid power inverter 300 is composed with upper legs 310 and lower legs 320, wherein the upper legs 310 of the phase legs employ an embodiment of the wide bandgap (WBG) transistors in one embodiment, and wherein the lower legs 320 of the phase legs employ an embodiment of the silicon-based (Si) transistors, which may include integrated-gate bipolar transistors (IGBTs). The corresponding pulsewidth-modulated control scheme 305 includes a first pulsewidth-modulated control signal 315 for controlling the upper legs 310, and a second pulsewidth-modulated control signal 325 for controlling the lower leg 320, which are generated by the controller and employed to control the respective gate drivers. This operation includes the controller being operative to control the first and second pulsewidth-modulated control signals 315, 325, to control the upper leg(s) 310 and the lower leg(s) 320 such that there is a first deadtime T1 between deactivation of the respective first upper leg and activation of the respective first lower leg, and a second deadtime T2 between a subsequent deactivation of the respective first lower leg and activation of the respective first upper leg. The first pulsewidth-modulated control signals 315 and the second pulsewidth-modulated control signals 325 originate from first gate drivers that are arranged to control a first upper leg in series with a first lower leg associated with one of the plurality of phase legs of the hybrid power inverter system 200. There is a first deadtime T1 in the form of a time lag that is measured between occurrence of an OFF (0) state for the first pulsewidth-modulated control signal 315 and a subsequent ON (1) state for the second pulsewidth-modulated control signal 325. There is a second deadtime T2 in the form of a time lag that is measured between occurrence of an OFF (0) state for the second pulsewidth-modulated control signal 325 and a subsequent ON (1) state for the first pulsewidth-modulated control signal 315. The second deadtime T2 differs from the first deadtime T1. The first deadtime T1 and the second deadtime T2 are selected to minimize third quadrant losses on the transistors that are capable of faster dv/dt's.

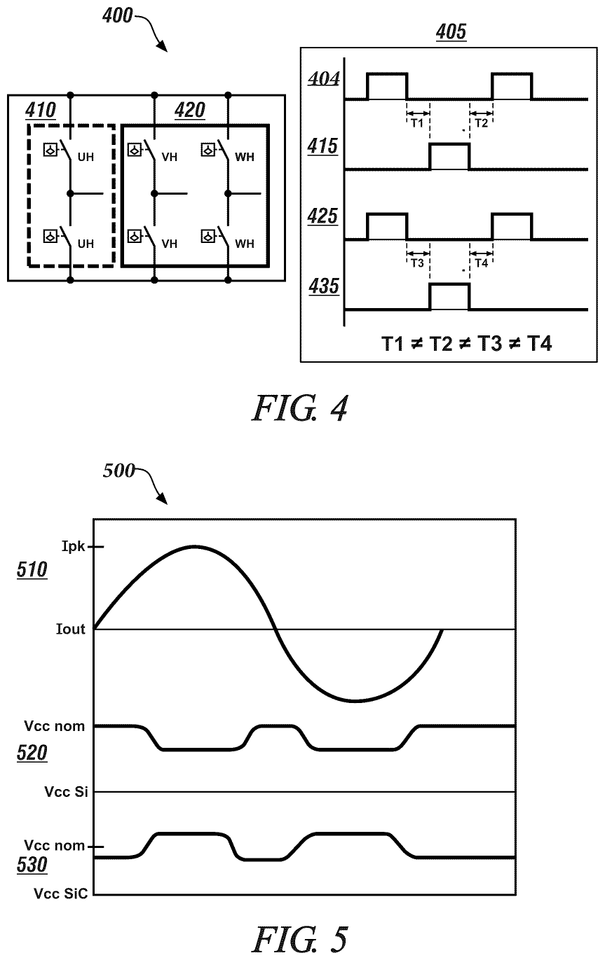

FIG. 4 graphically illustrates a portion of an embodiment of a hybrid power inverter 400 and a corresponding pulsewidth-modulated control scheme 405 for controlling the hybrid power inverter 400. In this embodiment, the hybrid power inverter 400 is composed with a first phase leg 410 and second phase legs 420, wherein the first phase leg 410 employs an embodiment of the silicon-based (Si) transistors, which may include integrated-gate bipolar transistors (IGBTs), and the second phase legs 420 employs an embodiment of the wide bandgap (WBG) transistors in one embodiment. The corresponding pulsewidth-modulated control scheme 405 includes a first pulsewidth-modulated control signal 404 for controlling the upper portion of the first phase leg 410, a second pulsewidth-modulated control signal 415 for controlling the lower portion of the first phase leg 410, second phase leg 420, a third pulsewidth-modulated control signal 425 for controlling the upper portions of the second phase legs 420, and a fourth pulsewidth-modulated control signal 435 for controlling the lower portions of the second phase legs 420, with the first, second, third, and fourth pulsewidth-modulated control signals 404, 415, 425, and 435, respectively, being generated by the controller and employed to control the respective gate drivers. FIG.

[symbol]

This operation includes the controller being operative to control the upper portion and the lower portion of the first phase leg 410 such that there is a first deadtime T1 between deactivation of the respective upper leg and activation of the respective lower portion, and a second deadtime T2 between a subsequent deactivation of the respective lower portion and activation of the respective upper portion, as described with reference to FIG. 3.

This operation also includes the controller being operative to control the upper portion(s) and the lower portions(s) of the second phase leg(s) 420 such that there is a third deadtime T3 between deactivation of the respective upper portion and activation of the respective lower portion, and a fourth deadtime T4 between a subsequent deactivation of the respective lower portion and activation of the respective upper portion.

The inverter system 200 has a third deadtime T3 that is in the form of a time lag that is measured between occurrence of an OFF (0) state for the third pulsewidth-modulated control signal 425 and a subsequent ON (1) state for the fourth pulsewidth-modulated control signal 425. The fourth deadtime T4 is in the form of a time lag that is measured between occurrence of an OFF (0) state for the fourth pulsewidth-modulated control signal 435 and a subsequent ON (1) state for the third pulsewidth-modulated control signal 335. The fourth deadtime T4 differs from the third deadtime T3. The third deadtime T3 and the fourth deadtime T4 are selected to minimize third quadrant losses on the transistors that are capable of faster dv/dt's.

In one embodiment, the first deadtime T1, the second deadtime T2, the third deadtime T3, and the fourth deadtime T4 all differ.

FIG. 5 graphically illustrates control elements 500 related to operation of a portion of an embodiment of the hybrid power inverter described herein, including time-coincident traces of output current 510, control current Vcc 520 for an embodiment of the silicon-based (Si) transistor, and a control current Vcc 530 for an embodiment of the wide bandgap (WBG) transistor, and depicts variable bias supplies to align voltage drops across each phase leg regardless of semiconductor type during an active short circuit event. At high back EMF during active short circuit, SiC switches will have larger voltage drop (˜0.5V+). At low back EMF the IGBT will have a larger voltage drop.

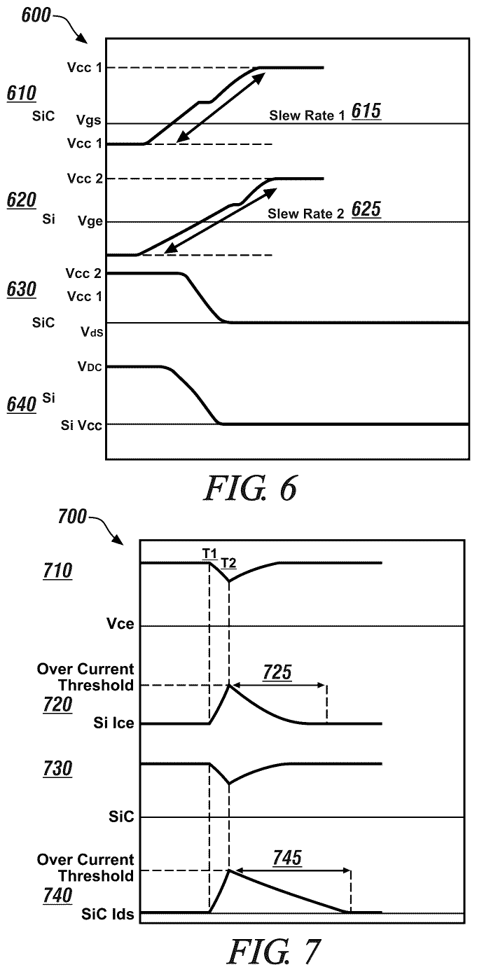

FIG. 6 graphically illustrates control elements 600 related to operation of a portion of an embodiment of the hybrid power inverter described herein, including time-coincident traces of Vgs 610 for an embodiment of the WBG transistor, including a first slew rate 615, Vge 620 for an embodiment of the Si transistor including a second slew rate 625. Also depicted are a first ON-OFF voltage 630 for the WBG transistor and a second ON-OFF voltage 640 for the Si transistor. This graph depicts that the first and second ON-OFF slew rates 615, 625 can be controlled to achieve a result in which the first ON-OFF voltage 630 for the WBG transistor is equivalent to the second ON-OFF voltage 640 for the Si transistor.

FIG. 7 graphically illustrates control elements 700 related to operation of a portion of an embodiment of the hybrid power inverter described herein, including time-coincident traces of voltage Vce 710 for the Si transistor, current Ice 720 for the Si transistor, voltage Vcc 730 for the WBG transistor, and current Ids 740 for the WBG transistor. At time T1, voltage Vce 710 for the Si transistor begins to drop, with a corresponding increase in the current Ice 720 for the Si transistor. There is a corresponding drop in the voltage Vcc 730 for the WBG transistor with an increase in the current Ids 740 for the WBG transistor, which is enabled by the variable bias supply. At time T2, the increase in the current Ice 720 for the Si transistor hits an overcurrent threshold 725, and at the same time T2, the increase in the current Ids 740 for the WBG transistor hits overcurrent threshold 745. This leads to subsequent increases in the voltage Vce 710 for the Si transistor and the voltage Vcc 730 for the WBG transistor. As such, a variable soft turn off is optimized to the turn off characteristics of each semiconductor type in the hybrid power stage to ensure safe turn off voltage stress. This can be extended to various embodiments of semiconductor type switches.

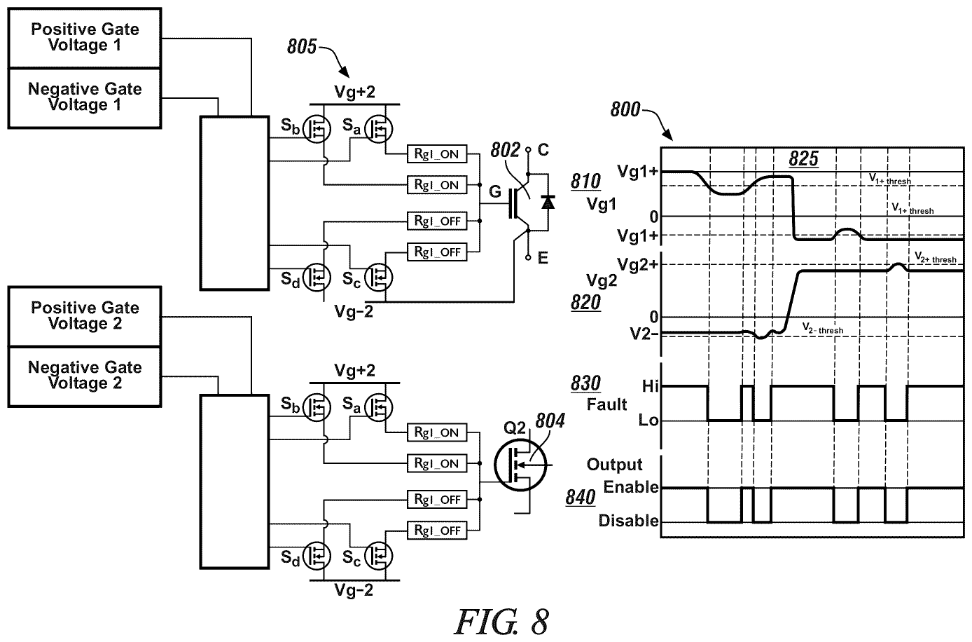

FIG. 8 schematically and graphically illustrates control elements related to operation of a portion of an embodiment of the hybrid power inverter described herein, including a configurable gate driver 805 that is configured to control operation and activation of first and second transistors 802, 804, respectively, wherein the first transistor 802 is a Si-based transistor and the second transistor 804 is a SiC-based transistor in the illustrated embodiment. It is appreciated that other transistor configurations may be employed within the scope of the disclosure. SiC-based and Si-based transistors have differing bias fault thresholds, and the configurable gate driver 805 can be designed with differing bus voltages Vg+1, Vg+2, Vg−1, Vg−2.

Graph 800 depicts operation of the configurable gate driver 805 that is configured to control operation and activation of first and second transistors 802, 804, and includes voltages Vg1 810, Vg2 820, Fault 830, and output enable 840. A fault can be detected, with associated output being disabled, when either of the voltages Vg1 810, or Vg2 820, exceeds a maximum threshold or falls below a minimum threshold, with the maximum thresholds and minimum thresholds being selected based upon the transistor type, i.e., one of either the SiC-based transistor or the Si-based transistor.

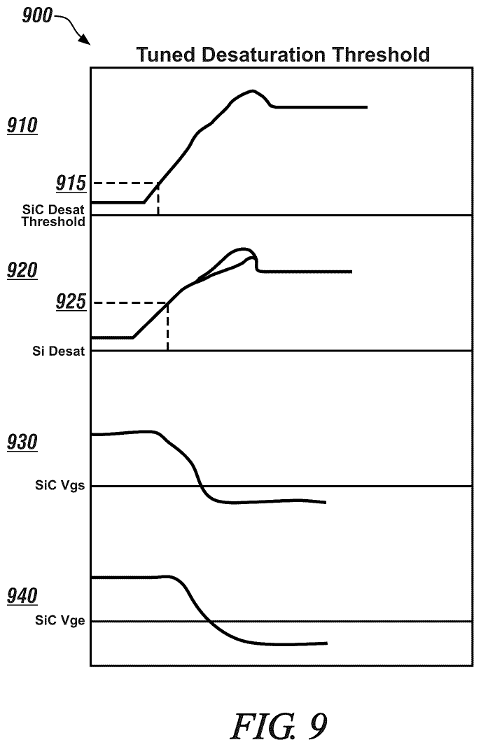

FIG. 9 graphically illustrates data 900 related to operation of a portion of an embodiment of the hybrid power inverter described herein, including time-coincident traces of voltage levels associated with tuned desaturation thresholds. Graph 910 depicts a first graph 910 associated with an embodiment of the WBG transistor, including a first tuned threshold 915, a second graph 920 associated with an embodiment of the Si transistor, including a second tuned threshold 925. Also depicted are a first Vgs voltage 930 for the WBG transistor and a second Vge voltage 940 for the Si transistor. This graph depicts that the first and second tuned thresholds 915, 925 can be controlled to achieve a result in which a drop in the first Vgs voltage 930 for the WBG transistor coincides with a drop in the second Vge voltage 940 for the Si transistor when the first and second tuned thresholds 915, 925 are accurately tuned.

Overall, the concepts provide one or a combination of a controller, control routine, system, and hardware for a hybrid power inverter that operates to lower motor losses in certain operating regions by switching the phases of an inverter at different switching frequencies for different semiconductors used on each phase; utilizing different gate driver types (AGD, VCGD, standard GD) based on different switches in the TPIM to optimize performance and cost (Si/SiC/GaN/etc); having distinct deadtimes per phase leg or per switch with different semiconductor types to minimize 3rd quadrant losses on semiconductor switches capable of faster dv/dts; a variable bias supply to align voltage drops across each phase leg regardless of semiconductor type during an active short circuit event; and a variable on/off slew rate, soft turn off, active miller clamping, desaturation, and bias fault tuning for each different semiconductor type in a traction inverter power stage.

The flowchart and block diagrams in the flow diagrams illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by dedicated-function hardware-based systems that perform the specified functions or acts, or combinations of dedicated-function hardware and computer instructions. These computer program instructions may also be stored in a computer-readable medium that can direct a computer or other programmable data processing apparatus to function in a particular manner, such that the instructions stored in the computer-readable medium produce an article of manufacture including instruction set that implements the function/act specified in the flowchart and/or block diagram block or blocks.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. An operating system for a hybrid power inverter that is coupled to a multi-phase electric machine, the operating system comprising:
a plurality of first gate drivers having wide bandgap (WBG) transistors, the plurality of first gate drivers being operatively connected to a first subset of transistors of the hybrid power inverter;
a plurality of second gate drivers having silicon-based (Si) transistors, the plurality of second gate drivers being operatively connected a second subset of transistors of the hybrid power inverter; and
a controller, the controller being operatively connected to the plurality of first gate drivers and the plurality of second gate drivers;
wherein the hybrid power inverter includes the first subset of transistors and the second subset of transistors arranged in a plurality of phase legs, including a first portion of the plurality of phase legs employing the first subset of transistors, and a remaining portion of the plurality of phase legs employing the second subset of transistors, wherein the first subset of transistors includes WBG transistors, and wherein the second subset of transistors includes silicon-based (Si) transistors;
wherein the plurality of first gate drivers is operative to control the first portion of the plurality of phase legs of the hybrid power inverter at a first switching frequency;
wherein the plurality of second gate drivers is operative to control the remaining portion of the plurality of phase legs of the hybrid power inverter at a second switching frequency; and
wherein the second switching frequency is less than the first switching frequency.

2. The operating system of claim 1, wherein the plurality of second gate drivers having silicon-based (Si) transistors comprises the plurality of second gate drivers having integrated-gate bipolar transistors (IGBTs).

3. The operating system of claim 1, wherein the plurality of first gate drivers having WBG transistors comprises the plurality of first gate drivers having silicon carbide (SiC) metal-oxide-silicon field effect transistors (MOSFETs).

4. The operating system of claim 1, wherein the plurality of first gate drivers having WBG transistors comprises the plurality of first gate drivers having Gallium nitride (GaN) MOSFETs.

5. The operating system of claim 1, further comprising:
the plurality of second gate drivers each comprising a variable current based gate driver; and
the plurality of first gate drivers each comprising a variable gate resistance voltage based gate driver.

6. The operating system of claim 1,
wherein the first portion of the plurality of phase legs includes a first upper leg arranged in series with a first lower leg;
wherein the plurality of first gate drivers being operative to control the first portion of the plurality of phase legs at the first switching frequency further comprises the plurality of first gate drivers being operative to control the first upper leg and the first lower leg such that there is a first deadtime between deactivation of the first upper leg and activation of the first lower leg; and
wherein the plurality of first gate drivers being operative to control the first portion of the plurality of phase legs at the first switching frequency further comprises the plurality of first gate drivers being operative to control the first upper leg and the first lower leg such that there is a second deadtime between deactivation of the first lower leg and activation of the first upper leg;
wherein the second deadtime differs from the first deadtime.

7. The operating system of claim 6, wherein the second deadtime and the first deadtime are selected to minimize third quadrant losses on semiconductor switches capable of faster voltage changes.

8. The operating system of claim 1,
wherein the first portion of the plurality of phase legs has a first upper leg arranged in series with a first lower leg;
wherein the remaining portion of the plurality of phase legs has a second upper leg arranged in series with a second lower leg;
wherein the first gate driver being operative to control the first portion of the plurality of phase legs at the first switching frequency further comprises the first gate driver being operative to control the first upper leg and the first lower leg such that there is a first deadtime between deactivation of the first upper leg and activation of the first lower leg; and
wherein the first gate driver being operative to control the first portion of the plurality of phase legs at the first switching frequency further comprises the first gate driver being operative to control the first upper leg and the first lower leg such that there is a second deadtime between deactivation of the first lower leg and activation of the first upper leg;
wherein the second gate driver being operative to control the remaining portion of the plurality of phase legs at the second switching frequency further comprises the second gate driver being operative to control the second upper leg and the second lower leg such that there is a third deadtime between deactivation of the second upper leg and activation of the second lower leg;
wherein the second gate driver being operative to control the remaining portion of the plurality of phase legs at the second switching frequency further comprises the second gate driver being operative to control the second upper leg and the second lower leg such that there is a fourth deadtime between deactivation of the second lower leg and activation of the second upper leg;
wherein the first deadtime, the second deadtime, the third deadtime and the fourth deadtime differ.

9. The operating system of claim 1, wherein the second switching frequency is 10 kHz, and the first switching frequency is at least 20 kHz.

10. The system of claim 1, further comprising:
the plurality of first gate drivers being operative to control the first portion of the plurality of phase legs of the hybrid power inverter at a first slew rate;
the plurality of second gate drivers being operative to control the remaining portion of the plurality of phase legs of the hybrid power inverter at a second slew rate;
wherein the first slew rate differs from the second slew rate.

11. The system of claim 1, further comprising:
the plurality of first gate drivers being operative to control the first portion of the plurality of phase legs of the hybrid power inverter at a first bias supply voltage;
the plurality of second gate drivers being operative to control the remaining portion of the plurality of phase legs of the hybrid power inverter at a second bias supply voltage;
wherein the first bias supply voltage differs from the second bias supply voltage.

12. An operating system for a hybrid power inverter that is coupled to a multi-phase electric machine, the operating system comprising:
a plurality of first gate drivers, the plurality of first gate drivers being operatively connected to a first subset of transistors of the hybrid power inverter;
a plurality of second gate drivers, the plurality of second gate drivers being operatively connected a second subset of transistors of the hybrid power inverter; and
a controller, the controller being operatively connected to the plurality of first gate drivers and the plurality of second gate drivers;
wherein the hybrid power inverter includes the first subset of transistors and the second subset of transistors arranged in a plurality of phase legs, including a first portion of the plurality of phase legs employing the first subset of transistors, and a remaining portion of the plurality of phase legs employing the second subset of transistors, wherein the first subset of transistors includes WBG transistors, and wherein the second subset of transistors includes silicon-based (Si) transistors;
wherein the controller is operative to control the plurality of first gate drivers to control the first portion of the plurality of phase legs of the hybrid power inverter at a first switching frequency;
wherein the controller is operative to control the plurality of second gate drivers to control the remaining portion of the plurality of phase legs of the hybrid power inverter at a second switching frequency; and
wherein the second switching frequency is less than the first switching frequency.

13. The operating system of claim 12,
wherein the first portion of the plurality of phase legs includes a first upper leg arranged in series with a first lower leg;
wherein the plurality of first gate drivers being operative to control the first portion of the plurality of phase legs at the first switching frequency further comprises the plurality of first gate drivers being operative to control the first upper leg and the first lower leg such that there is a first deadtime between deactivation of the first upper leg and activation of the first lower leg; and
wherein the plurality of first gate drivers being operative to control the first portion of the plurality of phase legs at the first switching frequency further comprises the plurality of first gate drivers being operative to control the first upper leg and the first lower leg such that there is a second deadtime between deactivation of the first lower leg and activation of the first upper leg;
wherein the second deadtime differs from the first deadtime.

14. The operating system of claim 13, wherein the second deadtime and the first deadtime are selected to minimize third quadrant losses on semiconductor switches capable of faster voltage changes.

15. The operating system of claim 12,
wherein the first portion of the plurality of phase legs has a first upper leg arranged in series with a first lower leg;
wherein the remaining portion of the plurality of phase legs has a second upper leg arranged in series with a second lower leg;
wherein the first gate driver being operative to control the first portion of the plurality of phase legs at the first switching frequency further comprises the first gate driver being operative to control the first upper leg and the first lower leg such that there is a first deadtime between deactivation of the first upper leg and activation of the first lower leg; and
wherein the first gate driver being operative to control the first portion of the plurality of phase legs at the first switching frequency further comprises the first gate driver being operative to control the first upper leg and the first lower leg such that there is a second deadtime between deactivation of the first lower leg and activation of the first upper leg;
wherein the second gate driver being operative to control the remaining portion of the plurality of phase legs at the second switching frequency further comprises the second gate driver being operative to control the second upper leg and the second lower leg such that there is a third deadtime between deactivation of the second upper leg and activation of the second lower leg;
wherein the second gate driver being operative to control the remaining portion of the plurality of phase legs at the second switching frequency further comprises the second gate driver being operative to control the second upper leg and the second lower leg such that there is a fourth deadtime between deactivation of the second lower leg and activation of the second upper leg;
wherein the first deadtime, the second deadtime, the third deadtime and the fourth deadtime differ.

16. The operating system of claim 12, wherein the second switching frequency is 10 kHz, and the first switching frequency is at least 20 kHz.

17. The operating system of claim 12, further comprising:
the plurality of first gate drivers being operative to control the first portion of the plurality of phase legs of the hybrid power inverter at a first slew rate;
the plurality of second gate drivers being operative to control the remaining portion of the plurality of phase legs of the hybrid power inverter at a second slew rate;
wherein the first slew rate differs from the second slew rate.

18. The operating system of claim 12, further comprising:
the plurality of first gate drivers being operative to control the first portion of the plurality of phase legs of the hybrid power inverter at a first bias supply voltage;
the plurality of second gate drivers being operative to control the remaining portion of the plurality of phase legs of the hybrid power inverter at a second bias supply voltage;
wherein the first bias supply voltage differs from the second bias supply voltage.

19. A vehicle, comprising:
a multi-phase motor drive system including a rechargeable energy storage device (RESS), a multi-phase rotary electric machine, a hybrid power inverter system, and a controller, the hybrid power inverter system having a hybrid power inverter and an operating system;
wherein the operating system includes:
a plurality of first gate drivers having wide bandgap (WBG) transistors, the plurality of first gate drivers being operatively connected to a first subset of transistors of the hybrid power inverter;
a plurality of second gate drivers having silicon-based (Si) transistors, the plurality of second gate drivers being operatively connected a second subset of transistors of the hybrid power inverter; and
a controller, the controller being operatively connected to the plurality of first gate drivers and the plurality of second gate drivers;
wherein the hybrid power inverter includes the first subset of transistors and the second subset of transistors arranged in a plurality of phase legs, including a first portion of the plurality of phase legs employing the first subset of transistors, and a remaining portion of the plurality of phase legs employing the second subset of transistors, wherein the first subset of transistors includes WBG transistors, and wherein the second subset of transistors includes silicon-based (Si) transistors;
wherein the plurality of first gate drivers is operative to control the first portion of the plurality of phase legs of the hybrid power inverter at a first switching frequency;
wherein the plurality of second gate drivers is operative to control the remaining portion of the plurality of phase legs of the hybrid power inverter at a second switching frequency; and
wherein the second switching frequency is less than the first switching frequency.

20. The vehicle of claim 19, further comprising:
the plurality of second gate drivers each comprising a variable current based gate driver; and
the plurality of first gate drivers each comprising a variable gate resistance voltage based gate driver.
